(19) United States
(12) Patent Application Publication
(10) Pub. No.: US 2004/0071537 A1
(43) Pub. Date: Apr. 15, 2004

(54) Refuse packer with retractable loading hopper

(75) Inventors: Claudiu D. Pruteanu, Kasson, MN (US); Randall L. Bice, Rochester, MN (US); James M. Johnston, Rochester, MN (US)

Correspondence Address: NIKOLAI & MERSEREAU, P.A., 900 SECOND AVENUE SOUTH, SUITE 820, MINNEAPOLIS, MN, 55402, US

(73) Assignee: McNeilus Truck and Manufacturing, Inc., Dodge Center, MN

(21) Appl. No.: 10/619,009

(22) Filed: Jul. 14, 2003

Related U.S. Application Data
(60) Provisional application No. 60/395,905, filed on Jul. 15, 2002.

(51) Int. Cl. B65F 3/00

(52) U.S. Cl. 414/525.2

(57) ABSTRACT

Rear loading, rear-discharging refuse truck bodies are disclosed which also serve as sealed, stackable, transportable containers. The truck bodies of the invention include a loading or charging hopper mounted in a vertically opening tailgate which closes a storage receptacle. The loading hopper is mounted so that it can be deployed during collection efforts and retracted when not in use to enable the body to be transformed into or assume the shape of a modular container box that is removable from the truck chassis much as a maritime shipping container. The truck bodies in this modular container box configuration are capable of self sealing and are transportable and stackable as interchangeable modular units separate from the truck chassis. The truck bodies of the invention include hydraulic cylinders connected to raise the tailgate and a conventional ejector panel to discharge the packed contents with the tailgate raised.

This application claims priority to provisional patent application Serial No. 60/395,905, filed Jul. 15, 2002.

### BACKGROUND OF THE INVENTION

I. Field of the Invention

The present invention relates generally to refuse collection vehicles and, particularly, to refuse collection truck bodies of a rear-loading, rear discharging type in which the truck bodies are provided with the ability to be removable, stackable modular units. The refuse collecting bodies of the invention include a tailgate loading hopper with integral packing mechanism constructed so that the loading hopper can be retracted into the truck body when not in use and thereby enable the truck body to assume the regular shape of a modular shipping container. The container so formed is removable as by lifting from the truck chassis as by using lifting lugs. The truck bodies in the modular container configuration are capable of self-sealing and are transportable and stackable as modular, interchangeable units which may be emptied separate from a truck chassis.

II. Related Art

Rear loading refuse handling truck bodies typically include a refuse storage compartment or reservoir designed to be both loaded and discharged through the rear of the vehicle. These truck bodies also include a rather large tailgate section that carries an external, protruding receiving or loading hopper portion and a packing mechanism that pushes material from the receiving hopper into the storage reservoir. The loading hopper extends beyond and beneath the main tailgate to accommodate manual or automated cart tipping, and the like, during collection efforts. The packing mechanism operates in the charging hopper and is of a rotating blade type and includes a vertically pivoting hydraulic packer member which rotates to sweep material out of the hopper forward from the tailgate loading area into the main body or storage compartment. The material is pushed forward into the main storage area and compacted against a movable ejector blade which retreats and, when the storage volume is filled, typically forms at least a partial front closure of the refuse container after being pushed fully forward. The packer also operates together with and is rotatably attached to, a lower end of a sliding storage compartment rear closing door slide system. The compacting or packing system includes a hydraulic cylinder operating the rotating packer blade which operates repeatedly to compact accumulated refuse in a forward direction beneath and in front of the sliding door system, each time sufficient refuse is loaded by hand or cart tipper into the tailgate hopper section. After the packing stroke, the packer blade is rotated back into a position substantially parallel to the slide and the slide is retracted to again expose the hopper loading area of the rear portion of the tailgate volume.

To promote ease of loading by hand or cart tipper and to accommodate storage and operation of the rotating blade compacting system, as indicated previously, the loading hopper typically protrudes significantly beyond and beneath the remainder of the tailgate section. This configuration has heretofore been a permanent arrangement. Thus, the protruding charging hopper/compacting mechanism has been characteristic of rear-loading, rear discharging refuse vehicle bodies for many years.

In the industry, particularly in large cities, however, there has existed a need for modular, stackable, refuse containers which can provide interchangeable modular rear-loading, rear-discharging refuse packer bodies and also provide stackable, transportable refuse containers which can be stored and transported, as by barges or flatbed railcars, for unloading together in larger numbers. The characteristic shape of the rear loader bodies has heretofore rendered this impossible.

### SUMMARY OF THE INVENTION

The present invention provides interchangeable, rear loading, rear-discharging refuse truck bodies which also serve as sealed, stackable, transportable containers. The truck bodies of the invention include a loading or charging hopper mounted in a vertically opening tailgate which closes a storage receptacle. The loading hopper is mounted so that it can be deployed during collection efforts and retracted when not in use to enable the body to be transformed into or assume the shape of a modular container box that is removable from the truck chassis much as a maritime shipping container. The truck bodies in this modular container box configuration are capable of self sealing and are transportable and stackable as interchangeable modular units separate from the truck chassis. The truck bodies of the invention include hydraulic cylinders connected to raise the tailgate and a conventional ejector panel to discharge the packed contents with the tailgate raised.

The transformation of the refuse compacting truck bodies of the invention is accomplished by providing a fluid-operated (typically hydraulic) pivotally mounted loading hopper which can be pivoted up to stow inside the tailgate when not in use and which also enables the body thereafter to be sealed with the hopper and packing mechanism folded inside. The front portion of the container is sealed by a full height ejector panel pushed fully forward by packed refuse in the container. Each system further may be provided with accommodations for the use of quick-disconnect hydraulic hose fittings which enable the tailgate to be opened and raised and the internal ejector panel operated to discharge the packed contents at a remote location where they can be connected to pneumatic or hydraulic lines, as the case may be. The collection body/container combination further contemplates quick disconnect/reconnect features with regard to attaching/detaching the container to a truck chassis as by utilizing a fluid-operated (typically hydraulic) latching/unlatching system.

The refuse packing body/container can be made in any convenient dimensions suitable for chassis mounting and any conventional stacking/transportation system, such as those utilized in the transportation of shipping container cargo by truck, sea or rail.

The loading hopper including the rotating blade hydraulic compactor unit are together pivotally mounted within and across the width of the tailgate to enable the hopper to rotate upward and inward to nest in and seal the container space when stored, or to deploy downward and outward as a conventional rear-loaded tailgate when in use during the refuse collection process.

The retractable hopper of the invention permits the convenience of a full-service rear loading, rear discharge refuse collection truck body to be combined with the convenience of a removable, stackable and transportable refuse storage container for material disposed. Filled containers may be loaded in relatively large numbers onto barges or skows and taken to a remote site for unloading thereby making the overall process more efficient.

### BRIEF DESCRIPTION OF THE DRAWINGS

In the drawings wherein like reference characters denote like parts throughout the same:

FIG. 1 is a side elevational view of a refuse collection vehicle of the rear loading type including the refuse collection body of the invention mounted on a truck chassis with the truck body shown in the pick-up or refuse collecting configuration with the hopper and compactor extended. The drawing depicts both external and internal parts with internal parts being shown by broken lines;

FIG. 2 depicts the refuse vehicle of FIG. 1 in the transport position with the charging hopper and the packing system retracted inside the truck body/container;

FIG. 3 depicts the refuse vehicle of FIG. 2 in the full eject position with the tailgate open and the ejector panel moved fully rearward to empty all stored material from the container;

FIGS. 4a and 4b are rear elevational views depicting the loading hopper in the deployed position and retraction position, respectively.

FIG. 5 is a side elevational view showing four truck body units of the invention in stacked in two-high side-by-side relation; and

FIG. 6 is a perspective schematic view of the refuse compact collection truck body/container box of the invention indicating that a variety of sizes are contemplated.

### DETAILED DESCRIPTION

It will be appreciated that an important aspect of the present invention is that it enables the full convenience of the relatively easy manual or automatic can dumping and cart tipping associated with the low-slung protruding opening of a tailgate loading hopper and compactor of a conventional rear loading refuse truck to be combined with the convenience of modular refuse container storage and transport. The illustrations and descriptions and accounts of the detailed embodiment herein, of course, are meant to be representative examples only and by no means limiting or exhaustive of the scope of the invention, as it is contemplated that other forms or variations will occur to those skilled in the art. This is particularly true with regard to the loading and the offloading and securing of the operating truck body to the truck chassis.

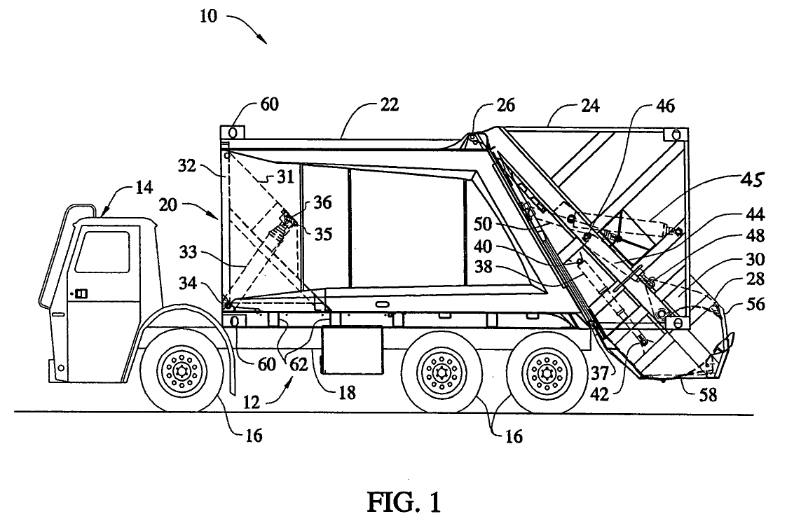

In FIGS. 1-3 there is shown generally at 10 a refuse vehicle system utilizing a truck body in accordance with the invention with the tailgate in three operating modes. The truck chassis is depicted at 12 and includes a cab 14, is supported by wheels, some of which is shown at 16, and includes a chassis frame with main chassis structural members as at 18. The truck chassis itself is normally of a class suitable for carrying refuse collecting truck bodies and includes a steerable front axle complete with wheels, etc. These chassis are well known and need not be discussed in greater detail for the purpose of the present invention.

The truck body, generally a 20, is constructed separately and mounted on the chassis and includes a refuse storage compartment 22 and a pivotally attached tailgate section 24. Tailgate section 24 is a top pivoting type with one of a pair of identical pivot hinge joints being illustrated at 26. Both the storage compartment 22 and tailgate section 24 are constructed of rigid steel plates and sufficiently heavy steel frame members to form a rigid structure. As can be seen from the figures, the tailgate assembly is a relatively large, heavy and cumbersome affair. The tailgate which includes a refuse receiving hopper 28 and an associated rotating packing system including a rotating a hydraulically operated packer blade 30 which extends along the width of the hopper 28.

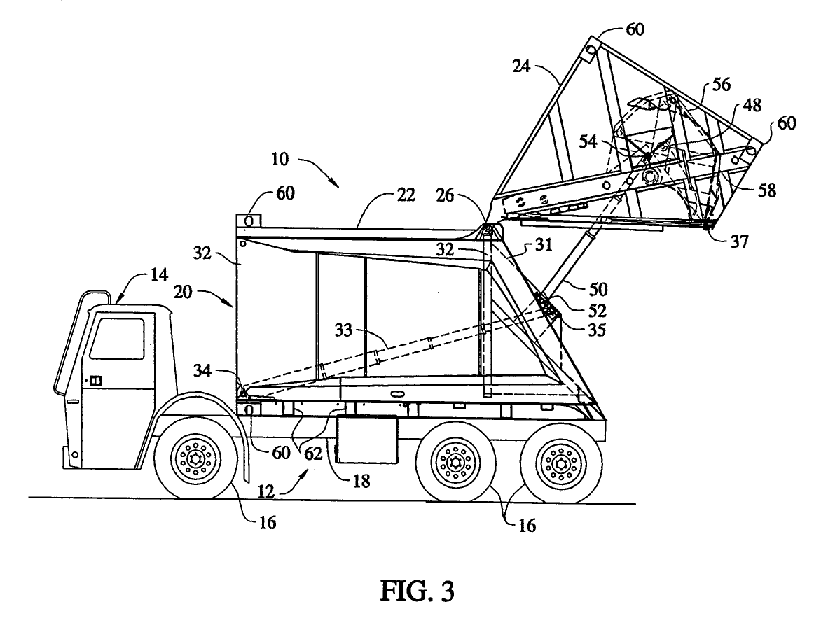

During the collection phase of the operation, containers may be tipped into the hopper as by hand or utilizing can/cart tipping mechanisms attached to the tailgate loading/charging hopper 28 in a well-known manner. The storage container 22 is further provided with a conventional type ejector system including a full-height ejector blade 31 having a full height sealing panel 32. A telescoping hydraulic cylinder 33 is pivotally mounted between the front of the truck body at 34 and to the nose 35 of the ejector panel at 36. Cylinder 33 operates to reciprocate the ejector blade or panel rearward in discharging refuse from the refuse container 22 as shown in FIG. 3, and is set to resist packing forces in the collection mode as it retracts during packing in a well known manner to control loading density.

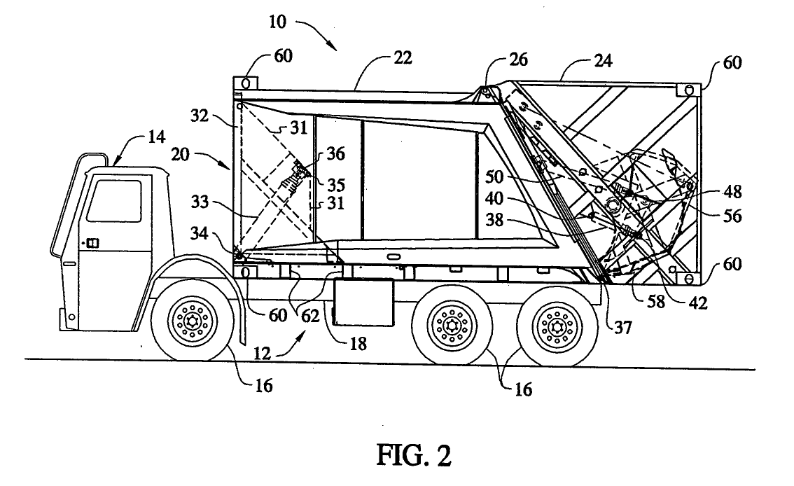

In accordance with the invention, the charging hopper is further rotatable about a horizontal mounting system or pivot pins or the like, one of which is shown at 37, and which enable the entire hopper to be pivoted upward and inward to be stowed and to reside within the confines of the container dimensions as shown in FIGS. 2 and 3. The receiving or charging hopper 28 is pivoted about the mounting system or pivot pins 37 by a pair of telescoping hydraulic cylinders, one of which is shown at 38 and which are pivotally attached between the tailgate at 40 and the hopper at 42. A further pair of spaced cylinders, one of which is shown at 44, rotates the packer blade 30 to sweep the material from the receiving or charging hopper 28 toward the storage container 22. These cylinders are also pivotally mounted as at 46 and 48. A pair of slide cylinders are provided, one of which is shown at 45 in FIG. 1. A further pair of telescoping hydraulic cylinders attached to either side of the container 22 are used to raise and lower the tailgate system 24. One of these is shows at 50 and is pivotally mounted between the container at 52 and the tailgate at 54.

The side views of FIGS. 1-3 depict operating cylinder parts which occur in pairs so that they are duplicated exactly on the other side of the vehicle to provide a balanced operation with respect to operating the tailgate, hopper and packing systems. The ejection system is operated with a single centrally located large double-acting telescoping cylinder previously indicated at 33.

It should be noted that with the hopper in the retracted position as shown in FIGS. 2, 3 and 4b, the outer edges which form the shell of the hopper as at 56 and 58 provide a sealing mechanism for that portion of the container when the hopper is retracted inasmuch as they extend the full width of the tailgate 24.

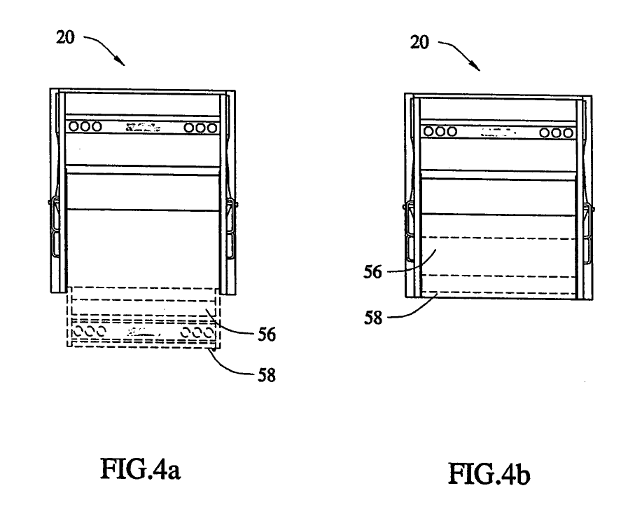

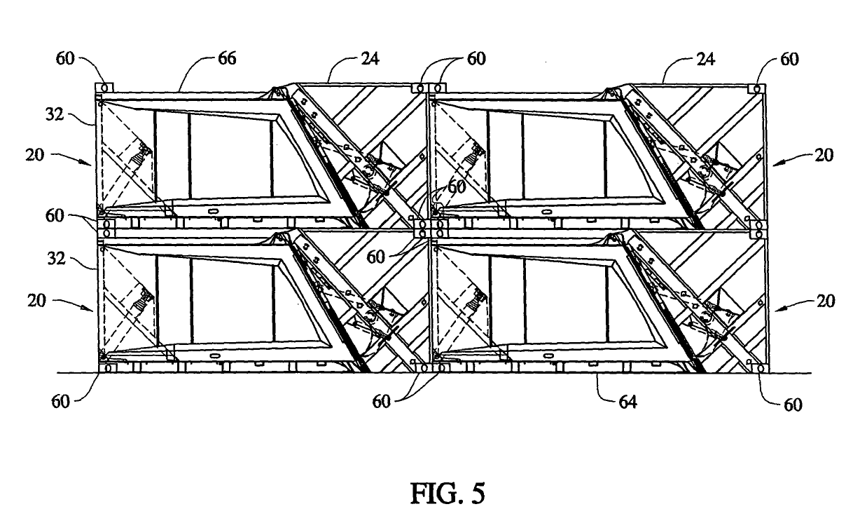

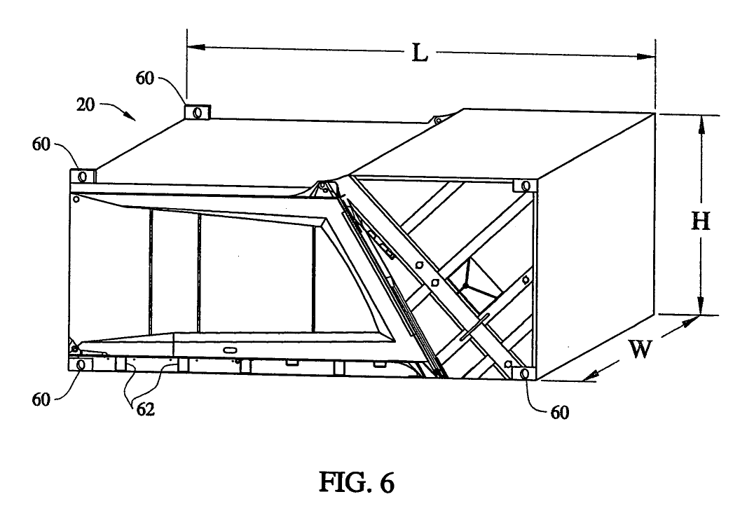

The container shape concept is an important aspect of the present invention that when the truck body is closed with the charging hopper/compactor system rotated inward and withdrawn, a box-like container structure of regular geometric shape is formed by the combination of the storage compartment and tailgate sections 22 and 24. FIGS. 4a and 4b show the extended or deployed hopper position (4a) and the stowed position (4b) from the rear of the truck body. Lifting lugs as at 60 may be provided for use in manipulating each container so that that may be removed from a corresponding chassis and stacked or transported as an independent container entity as shown in FIGS. 5 and 6. Structural support members or feet may be provided as those shown at 62 to support the storage body on a chassis. Containers are shown stacked on a deck 64 in FIG. 5. Note that recesses 66 in the tops of the containers accommodate the support members or feet 62. Each vehicle body or container is also provided with a leveling mechanism for use in stacking the containers as shown in FIG. 5.

As shown in FIG. 6, the truck bodies 20 of the invention, may be made any desirable size to fit a particular chassis or shipping need. This may be any conventional leveling mechanism as these devices are also well known.

As shown in FIG. 5, a number of filled truck bodies can be stacked and shipped as by barges to a remote site for unloading or ejection. For this reason, the truck bodies are equipped with quick-disconnect hydraulic connectors so that they can be re-connected through high pressure and return hydraulic lines to be operated at a distant landfill, or the like. Such devices are well known. Thus, each container can be hooked up to a hydraulic system, the tailgate raised and the material inside ejected and the empty truck body then disconnected and restacked for return and reloading on a truck.

Both the compacting mechanism and the ejector mechanism suitable for use with the refuse collection vehicle body of the invention are otherwise conventional and such systems are well known and their construction and operation are familiar to those skilled in the art. Examples are shown in U.S. Pat. Nos. 5,158,340, 5,190,433, 4,551,055, and 5,971,694. The ability to rotate the charging hopper/compactor combined system to a fully stowed non-protruding position within a container shaped body, however, provides an important new aspect to the field of rear loading/rear discharging refuse collection truck bodies. The creation of a self contained container structure with such truck bodies was heretofore not possible. The system offers all of the advantages of stackable storage containers with the ease of loading and compacting of the rear loading vehicle.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A rear-loading, rear discharging refuse truck body comprising:
(a) a storage receptacle for receiving and carrying refuse materials; and
(b) a tailgate connected carrying a loading hopper and including a packing system for receiving refuse materials and charging refuse materials into said storage receptacle in a compressed state, said loading hopper being movable relative to said storage receptacle between an externally protruding deployed position for collection and a stowed position within said storage receptacle.

2. A truck body as in claim 1 further comprising a full height ejection panel in said storage receptacle for sealing the front of said storage receptacle and ejecting refuse from said storage receptacle.

3. A truck body as in claim 1 wherein said loading hopper is mounted to rotate vertically as it moves between said deployed position and said stowed position.

4. A truck body as in claim 1 wherein said truck body assumes the shape of a stackable container when said loading hopper is in the stowed position.

5. A truck body as in claim 4 wherein said loading hopper provides sealing to said truck body when stowed.

6. A truck body as in claim 2 wherein said loading hopper provides sealing to said truck body when stowed.

7. A truck body as in claim 4 further comprising lifting lugs to allow lifting of aid truck body for stacking and unloading.

8. A truck body as in claim 3 further comprising hydraulic cylinders connected to operate and position said loading hopper.

9. A rear-loading, rear discharging refuse vehicle comprising:
(a) a chassis;
(b) a refuse collection body including a storage receptacle for receiving and carrying refuse materials removably carried on said chassis; and
(c) a hinged tailgate connected to said storage receptacle and a packing system for receiving refuse materials and charging refuse materials into a storage receptacle in said truck body in a compressed state, said loading hopper being movable relative to said tailgate between a deployed position for collection and a stowed position within said tailgate.

10. A refuse vehicle as in claim 9 further comprising a full height ejection panel in said truck body for sealing said storage receptacle and ejecting refuse from said storage receptacle.

11. A refuse vehicle as in claim 9 wherein said loading hopper is mounted to rotate vertically as it moves between said deployed position and a stowed position.

12. A refuse vehicle as in claim 11 further comprising hydraulic cylinders connected to operate and position said loading hopper.

13. A refuse vehicle as in claim 11 wherein said truck body assumes the shape of a stackable container when said loading hopper is in the stowed position.

14. A refuse vehicle as in claim 13 wherein said loading hopper provides sealing to said truck body when stowed.
